(19) United States
(12) Patent Application Publication
(10) Pub. No.: US 2010/0235446 A1
(43) Pub. Date: Sep. 16, 2010

(54) TECHNIQUES TO MAKE MEETINGS DISCOVERABLE

(75) Inventors: Alex Hehmeyer, Bellevue, WA (US); Amit Gupta, Redmond, WA (US); Avronil Bhattacharjee, Redmond, WA (US); Felix Wong, Bellevue, WA (US); Jay Zybura, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/404,609

(22) Filed: Mar. 16, 2009

(51) Int. Cl. G06F 17/30; G06F 15/16

(52) U.S. Cl. 709/205; 707/E17.002; 707/E17.014

(57) ABSTRACT

Techniques to make meetings discoverable are described. An apparatus may comprise a meeting server component operative to create a meeting object, associate at least one of metadata or content to the meeting object, and store the meeting object, metadata and content. The meeting server component comprising an indexing component operative to index metadata associated with the meeting object, and a search engine component operative to receive a search query comprising search criteria. Other embodiments are described and claimed. Other embodiments are described and claimed.

### BACKGROUND

Computer-based calendar and scheduling applications extend the utility of traditional paper calendars by allowing users to create events on electronic calendars. Other users may be invited to events, such as meetings. Calendars may be shared, for example, between a manager and her staff, or support person. Others' schedules may be accessible to a user trying to identify a time when all participants may be available. Typically, however, meetings are only known to the organizer and invitees.

It is with respect to these and other considerations that the present improvements have been needed.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

Various embodiments are generally directed to techniques to make meetings in a calendar or scheduling application system discoverable to others. Embodiments may create “first class” meeting objects which may be stored and indexed. Meeting objects may be tagged or associated with metadata. Operators may then search for meeting objects based on metadata values.

In one embodiment, an apparatus may comprise a meeting server component operative to create a meeting object, associate at least one of metadata or content to the meeting object, and store the meeting object, metadata and content. The meeting server component comprising an indexing component operative to index metadata associated with the meeting object, and a search engine component operative to receive a search query comprising search criteria. Other embodiments are described and claimed.

These and other features will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 illustrates an embodiment of a meeting system.

FIG. 2 illustrates an embodiment of a meeting object.

FIG. 3 illustrates an embodiment of a search interface.

FIG. 4 illustrates an embodiment of a logic flow.

FIG. 5 illustrates an embodiment of a computing architecture.

FIG. 6 illustrates an embodiment of an article.

### DETAILED DESCRIPTION

Various embodiments include physical or logical structures arranged to perform certain operations, functions or services. The structures may comprise physical structures, logical structures or a combination of both. The physical or logical structures are implemented using hardware elements, software elements, or a combination of both. Descriptions of embodiments with reference to particular hardware or software elements, however, are meant as examples and not limitations. Decisions to use hardware or software elements to actually practice an embodiment depends on a number of external factors, such as desired computational rate, power levels, heat tolerances, processing cycle budget, input data rates, output data rates, memory resources, data bus speeds, and other design or performance constraints. Furthermore, the physical or logical structures may have corresponding physical or logical connections to communicate information between the structures in the form of electronic signals or messages. The connections may comprise wired and/or wireless connections as appropriate for the information or particular structure. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Various embodiments may be generally directed to techniques for making meetings discoverable and searchable. Embodiments may create meeting objects that may be stored. Meeting objects may have various data associated with them, and provide the capability to sort and/or filter the meeting objects according to the associated data.

Some meeting systems may be designed to operate with various packet-based networks, such as the Internet or World Wide Web (“web”), to provide web-based conferencing services. Such implementations are sometimes referred to as web conferencing systems. An example of a web conferencing system may include MICROSOFT® OFFICE LIVE MEETING made by Microsoft Corporation, Redmond, Wash. Other virtual conference systems may be designed to operate for a private network, business, organization, or enterprise, and may utilize a virtual conference server such as MICROSOFT OFFICE COMMUNICATIONS SERVER made by Microsoft Corporation, Redmond, Wash. It may be appreciated, however, that implementations are not limited to these examples.

A meeting system may include, among other network elements, a meeting server or other processing device arranged to provide scheduling and meeting organization services. Some meeting systems may also provide web and/or telephonic conferencing services. A meeting event may refer to any event on a schedule, calendar or the like to which one or more people may be invited. Embodiments may allow others to search for meeting events and join the meeting events, even when not invited. Acceptance of a meeting event invitation may insert the meeting event on to the invitee's calendar or schedule. A meeting event may be a virtual conference event offering various types of virtual information in a real-time or live online environment.

In one embodiment, the meeting system may further include one or more computing devices implemented as client devices. Each client device may be arranged to interact with the meeting server to generate meeting events, associate data with meeting events, and search for and retrieve meeting events according to various search criteria. Client devices may also be arranged to provide the actual meeting interaction, for example, via virtual meeting software, or a web browser. The embodiments are not limited to these examples.

Conventional meeting systems typically do not make meetings publically viewable or searchable. Conventional meetings are typically not “first-class” objects, meaning that the meeting objects are usually not independent objects. A user may need to know of the existence of a meeting and some information about the meeting in order to locate the meeting, for example, on a colleague's shared calendar. In some cases, a user may need to be invited to the meeting in order to view the meeting or be aware of its existence.

To solve these and other problems, embodiments may implement various enhanced meeting discoverability techniques.

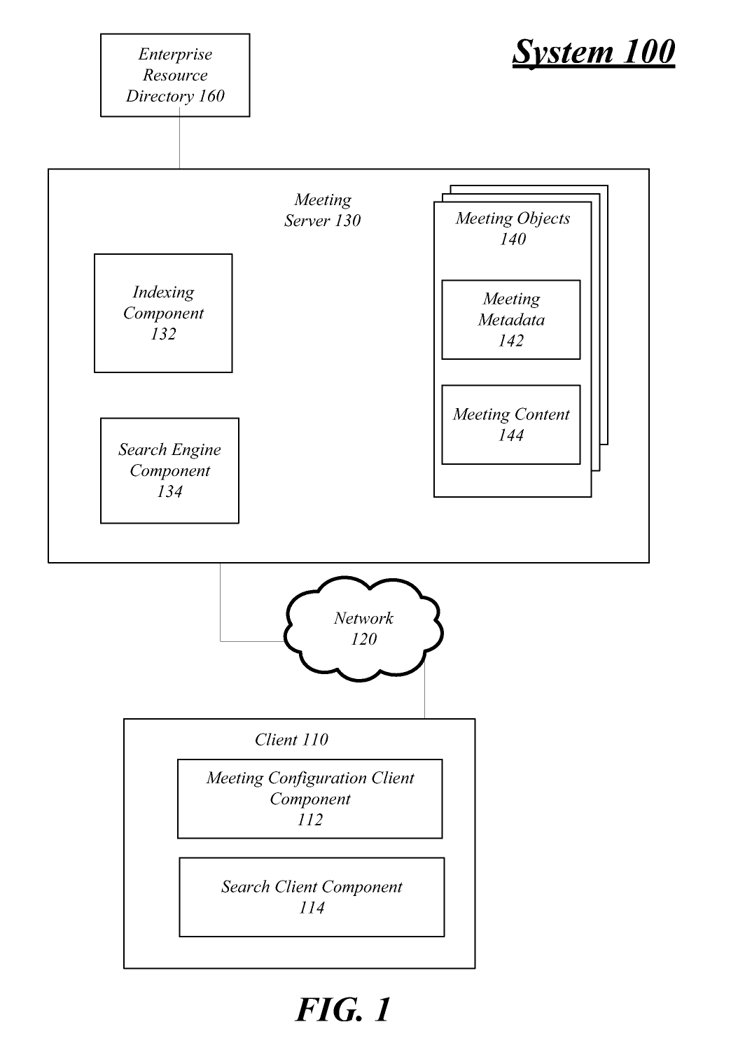

FIG. 1 illustrates a block diagram for a system 100 to create discoverable meetings. In one embodiment, for example, the system 100 may comprise a computer-implemented system 100 having multiple components, e.g. client 110, meeting server 130. As used herein the terms “system” and “component” are intended to refer to a computer-related entity, comprising either hardware, a combination of hardware and software, software, or software in execution. For example, a component can be implemented as a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers as desired for a given implementation. The embodiments are not limited in this context.

In the illustrated embodiment shown in FIG. 1, the system 100 may be implemented as part of one or more electronic devices. Examples of an electronic device may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combination thereof. Although the system 100 as shown in FIG. 1 has a limited number of elements in a certain topology, it may be appreciated that the system 100 may include more or less elements in alternate topologies as desired for a given implementation.

The components 110, 130 may be communicatively coupled via various types of communications media. The components 110, 130 may coordinate operations between each other. The coordination may involve the uni-directional or bi-directional exchange of information. For instance, the components 110, 130 may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

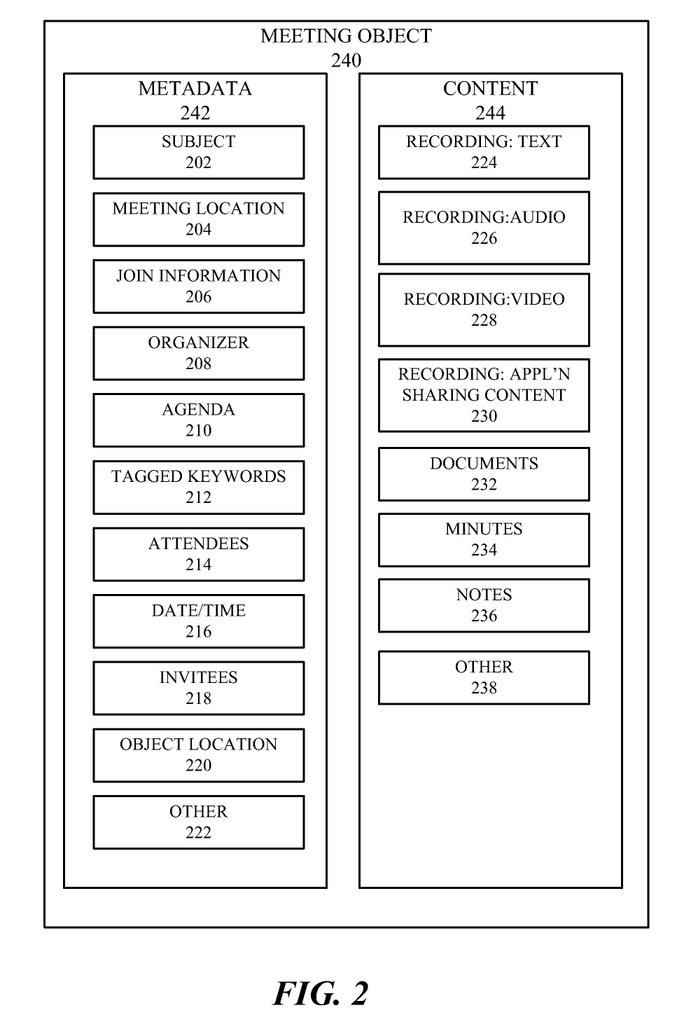

In various embodiments, the system 100 may include a meeting server 130 operative to create a meeting object 140. Meeting server 130 may be further operative to associate metadata 142 and/or content 144 with a meeting object 140. Meeting server 130 may be operative to store and retrieve meeting object 140, along with metadata 142 and/or content 144. Meeting objects 140 are discussed further with respect to FIG. 2 below.

In various embodiments, meeting server 130 may comprise an indexing component 132 operative to index metadata associated with a meeting object. Indexing component 132 may create and update one or more indexes. The one or more indexes may make subsequent searches for meeting objects more efficient. Indexing component 132 may be operative to convert some content or metadata associated with a meeting object into a format more suitable for indexing. For example, indexing component 132 may convert an audio recording of the meeting into text and index the audio recording according to keywords within the text. The embodiments are not limited in this context.

In various embodiments, meeting server 130 may comprise a search engine component 134 operative to receive a search query composed of search criteria. The search criteria may contain one or more metadata and/or content items. Search engine component 134 may search the stored meeting objects 140 to locate meeting objects that meet at least some of the search criteria. Search component 134 may use the indexes created by indexing component 132 when searching. In various embodiments, search component 134 may accept, for example, but not limited to, Boolean or natural language searches. Search engine component 134 may filter a list of meeting objects, as an alternative to, or in addition to, retrieving meeting objects based on a search. In an embodiment, search engine component 134 may be a MICROSOFT OFFICE SHAREPOINT SERVICES search engine. Search engine component 134 may browse for meetings according to search criteria. Search engine component 134 may find and list meetings automatically according to the search criteria.

In an embodiment, search engine component 134 may be able to browse other content management sites for meetings. For example, a content management site may provide a meeting site that displays links to all meetings based on a set of criteria. Examples of meeting sites may include, for example, meetings for a project team, meetings organized by a specific person, meetings about a particular topic, or meetings that meet other criteria. Examples of such a content management site may include, for example, such as Mysite, TeamSite, etc. In such a scenario, search engine component 134 may not itself actually perform a search.

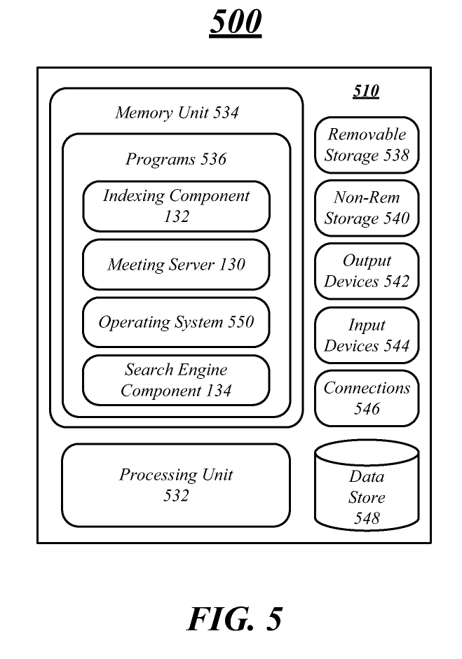

In various embodiments, the system 100 may include one or more devices implemented as a client 110 to connect to the meeting server 130 over one or more communications connections via the network 120. The client 110 may be implemented as any device that includes, in its most basic form, a processing system including a processor and memory, one or more virtual input/output (I/O) components, and a wireless and/or wired network connection. Examples of virtual I/O components may include audio I/O components (e.g., microphones, speakers), video I/O components (e.g., video camera, display), tactile (I/O) components (e.g., vibrators), user data (I/O) components (e.g., keyboard, thumb board, keypad, touch screen), and so forth. Examples of client 110 may include a telephone, a VoIP or VOP telephone, a packet telephone designed to operate on the PSTN, an Internet telephone, a video telephone, a cellular telephone, a personal digital assistant (PDA), a combination cellular telephone and PDA, a mobile computing device, a smart phone, a one-way pager, a two-way pager, a messaging device, a computer, a personal computer (PC), a desktop computer, a laptop computer, a notebook computer, a handheld computer, a network appliance, and so forth. In some implementations, clients 110 may be implemented using a general or specific computing architecture similar to the computing architecture described with reference to FIG. 5.

Client 110 may comprise or implement respective client meeting components such as meeting configuration client component 112 and search client component 114. The client meeting components may be designed to interoperate with meeting server 130 to establish, manage or search for meeting objects.

For example, meeting configuration client component 112 may comprise MICROSOFT OFFICE OUTLOOK® application software, made by Microsoft Corporation, Redmond, Wash. The MICROSOFT OFFICE OUTLOOK application software comprises messaging and collaboration client software that may be used to schedule a meeting event. In an embodiment, an operator may use MICROSOFT OFFICE OUTLOOK to create a calendar event that is sent to a list of meeting invitees.

An operator may use meeting configuration client component 112 to generate a meeting object 140 for a meeting event. The meeting configuration client component 112 may allow the operator to specify meeting details such as, but not limited to: a list of meeting invitees for the meeting event, a date and time, a location, an agenda, access information for virtual or remote meetings, topic, etc.

Meeting configuration client component 112 may communicate the meeting object details to meeting server 130. The meeting server 130 may receive meeting object details and generate a meeting object 140.

Search client component 114 may provide an interface to allow an operator, i.e., the searcher, to search for meeting objects according to metadata and/or content. Search client component 114 may communicate the search criteria to search engine component 134 to begin the search. Search client component 114 may then display the results of the search, for example, as a list of meeting objects, or as blocks on a calendar display.

Meeting server 130 may retrieve the list of meeting invitees and associated information for the meeting invitees from a network device, such as an enterprise resource directory 160, and forward a meeting request to the invitees.

The enterprise resource directory 160 may comprise a network device that publishes a public directory of operators and/or network resources. A common example of network resources published by the enterprise resource directory 160 may include, for example, users, groups, network printers and computers. In one embodiment, for example, the enterprise resource directory 160 may be implemented as a MICROSOFT ACTIVE DIRECTORY®. Active Directory is an implementation of lightweight directory access protocol (LDAP) directory services to provide central authentication and authorization services for network computers. Active Directory also allows administrators to assign policies, deploy software, and apply updates to an organization. Active Directory stores information and settings in a central database. Active Directory networks can vary from a small installation with a few hundred objects, to a large installation with millions of objects.

FIG. 2 illustrates a block diagram of a meeting object 240. Meeting object 200 may be an example of meeting object 140. Meeting object 240 may comprise one or more items of metadata 242 and/or one or more items of content 244. Meeting object 240 may be a MICROSOFT OFFICE SHAREPOINT SERVICES meeting workspace.

Metadata 242 may include, but is not limited to: a subject 202, a meeting location 204, join information 206, an organizer 208, an agenda 210, tagged keywords 212, attendees 214, date/time 216, invitees 218, object location 220 and other metadata 222. Metadata 242 may be identified by an operator while creating a meeting object, or may be added later. Subject 202 may be, for example, a relatively short phrase describing the topic of the meeting, such as, “Quarterly Budget Review.” Meeting location 204 may be text that describes the physical location of the meeting, such as “Conference Room A.” Join information 206 may include a dial-in sequence or a join URL for a virtual or remote meeting. Organizer 208 may be the name or profile record of the meeting organizer. Agenda 210 may be information that describes the agenda of the meeting. Tagged keywords 212 may be a set of keywords that describe the meeting, such as describing which organization groups are relevant to the meeting, topics to be covered, etc. Attendees 214 may be a list of people who respond that they will attend the meeting, or that actually attended the meeting. Date/time 216 may be the date and time that the meeting will take place. Invitees 218 may be a list of people invited to attend the meeting. Object location 220 may be a physical location where the meeting object 240 is stored on a network. Other metadata 222 may include other information that may help to search for and locate the meeting object, and may include user-defined metadata fields. The embodiments are not limited in this context.

Content 244 may include meeting related documents, files, or other stored information. Content 244 may include, but is not limited to: text recording 224, audio recording 226, video recording 228, application sharing content recording 230, documents 232, meeting minutes 234, notes 236 and other content 238. Content 244 may be indexed as is, for example, by words in text. Content 244 may be converted into a form more suitable to indexing, such as converting audio to text, performing optical character recognition, or parsing keywords from documents. In some embodiments, content 244 may be converted into metadata 242. Once associated with meeting object 240, content 244 files may be retrieved and provided with meeting object 240 when meeting object 240 is returned in a search result. Meeting server 130 may store the content 244, or may store an indication of where the content 244 is stored.

Once the search results are returned, the search operator may then be able to join a meeting represented by the returned meeting objects. Joining a meeting may add the search operator as an attendee of the meeting.

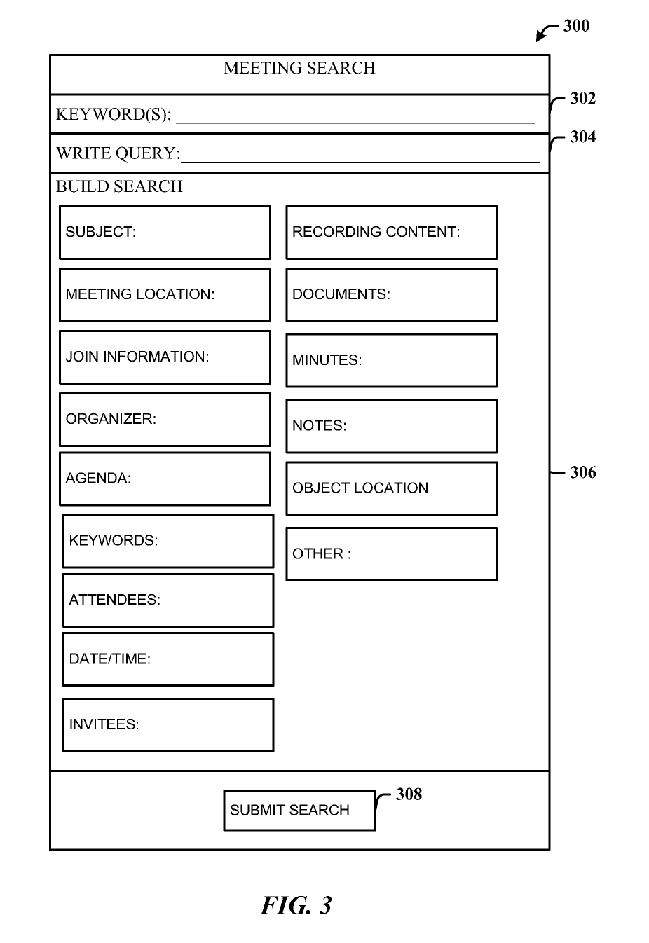

FIG. 3 illustrates a view of an embodiment of search interface 300. Search interface 300 may be provided by search client component 114. Search interface 300 may provide one or more ways to generate a search. For example, search interface 300 may provide a simple keyword search 302. An operator may enter one or more keywords and submit the search, for example, via button 308. Upon receiving the keywords, search engine component 134 may search for any meeting objects having any of the keywords in any of the metadata and/or content. For example, the operator may enter “Apr. 19, 2009 widgets Tom Jones.” Search engine component 134 may then return meetings that have a date/time metadata of Apr. 19, 2009, where Tom Jones is an organizer, invitee or attendee, and where widgets is a subject, an agenda item, or is mentioned in the content. Boolean operations such as “AND”, “OR” and “NOT” may be employed.

Search interface 300 may provide a natural language type search 306. For example, the operator may enter a query in the form of: “Find any meeting occurring in April 2009 about benefits training.” Search engine component 134 may then use natural language processing to determine search terms and conduct a search of the metadata.

Search interface 300 may provide a more focused buildable search 306. Buildable search 306 may allow the operator to specify in which kind of metadata or content to search for a particular criterion. For example, if the operator enters “widget” in the subject field, search engine component 134 may only search for the term “widget” in subject metadata fields of meeting objects

Search interface 300 may allow the operator to search for meetings that occurred in the past. The operator may then be able to access the meeting's metadata, such as meeting minutes, presentation materials, recordings, etc. The operator may also be able to then join future occurrences of the meeting.

It is worthwhile to note that meeting objects 140 and 240 may be access controlled. In an embodiment, a meeting object may inherit the access level of the meeting organizer, or the meeting organizer may explicitly set access controls on a meeting object. In an access-controlled embodiment, search engine component 134 may know the security model of system 100, and may only return meeting objects that are accessible to the searching operator.

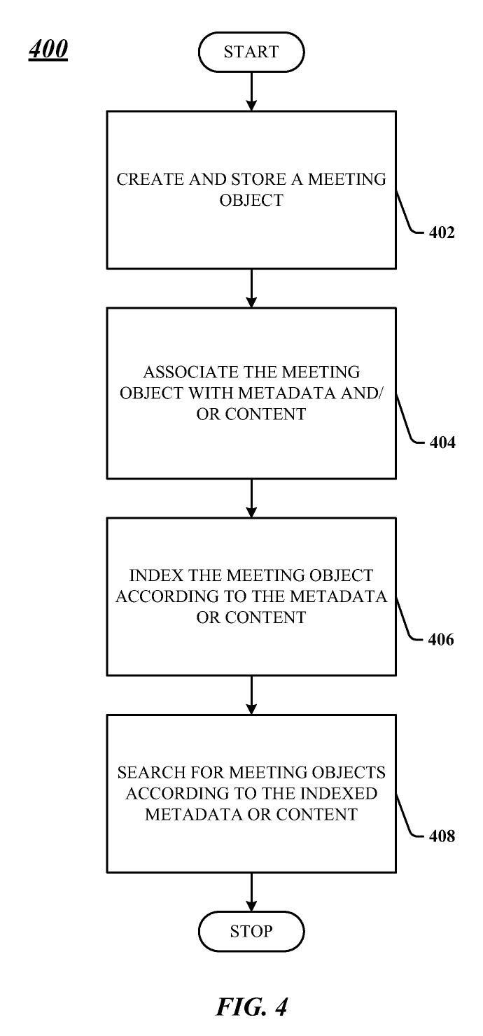

FIG. 4 illustrates one embodiment of a logic flow 400. Logic flow 400 may be representative of some or all of the operations executed by one or more embodiments described herein.

As shown in FIG. 4, the logic flow 400 may create and store a meeting object in block 402. For example, meeting server 130 may create a meeting object 140 from meeting details provided by a client 110.

The logic flow 400 may associate the meeting object with metadata and/or content in block 404. The meeting details provided by the client 110 may be used to “tag” the meeting object with metadata. If needed, content or other details may be reformatted in order to be used as metadata.

The logic flow 400 may index the meeting object according to the metadata and/or content in block 406. For example, indexing component 132 may create or update one or more indexes to the meeting objects from the metadata and/or content. The indexes may be updated when content and metadata are added or modified.

The logic flow 400 may search for meeting objects according to the metadata or content in block 408. For example, search engine component 134 may receive a search query from client 110. The search query may contain one or more search criteria that search engine 134 may use to search the indexed metadata and content. Meeting objects matching some or all of the search criteria may be returned to the client 110 and displayed to the operator.

FIG. 5 further illustrates a more detailed block diagram of computing architecture 510 suitable for implementing the client 110 or the meeting server 130. In a basic configuration, computing architecture 510 typically includes at least one processing unit 532 and memory 534. Memory 534 may be implemented using any machine-readable or computer-readable media capable of storing data, including both volatile and non-volatile memory. For example, memory 534 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. As shown in FIG. 5, memory 534 may store various software programs, such as one or more application programs 536 and accompanying data. Depending on the implementation, examples of application programs 536 may include indexing component 132, search engine component 134, and so forth.

Computing architecture 510 may also have additional features and/or functionality beyond its basic configuration. For example, computing architecture 510 may include removable storage 538 and non-removable storage 540, which may also comprise various types of machine-readable or computer-readable media as previously described. Computing architecture 510 may also have one or more input devices 544 such as a keyboard, mouse, pen, voice input device, touch input device, measurement devices, sensors, and so forth. Computing architecture 510 may also include one or more output devices 542, such as displays, speakers, printers, and so forth.

Computing architecture 510 may further include one or more communications connections 546 that allow computing architecture 510 to communicate with other devices. Communications connections 546 may include various types of standard communication elements, such as one or more communications interfaces, network interfaces, network interface cards (NIC), radios, wireless transmitters/receivers (transceivers), wired and/or wireless communication media, physical connectors, and so forth. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. The terms machine-readable media and computer-readable media as used herein are meant to include both storage media and communications media.

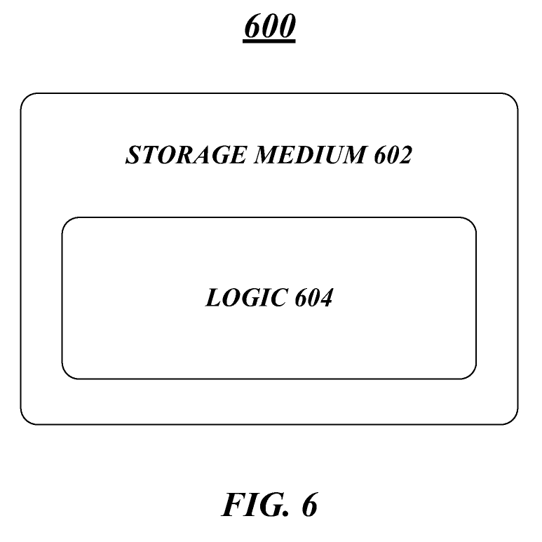

FIG. 6 illustrates a diagram an article of manufacture 600 suitable for storing logic for the various embodiments, including the logic flow 400. As shown, the article of manufacture 600 may comprise a storage medium 602 to store logic 604. Examples of the storage medium 602 may include one or more types of computer-readable storage media capable of storing electronic data, including volatile memory or non-volatile memory, removable or non-removable memory, erasable or non-erasable memory, writeable or re-writeable memory, and so forth. Examples of the logic 604 may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof.

In one embodiment, for example, the article of manufacture 600 and/or the computer-readable storage medium 602 may store logic 604 comprising executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language, such as C, C++, Java, BASIC, Perl, Matlab, Pascal, Visual BASIC, assembly language, and others.

Various embodiments may be implemented using hardware elements, software elements, or a combination of both. Examples of hardware elements may include any of the examples as previously provided for a logic device, and further including microprocessors, circuits, circuit elements (e.g., transistors, resistors, capacitors, inductors, and so forth), integrated circuits, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method, comprising:
creating and storing a meeting object;
associate the meeting object with at least one of metadata or content;
indexing the meeting object according to at least one of the metadata or content; and
searching for meeting objects via the indexed metadata or content.

2. The method of claim 1, comprising:
receiving a search query wherein search criteria for the search query include at least one metadata via a search interface; and
retrieving any meeting objects having metadata matching at least one search criterion.

3. The method of claim 2, comprising:
configuring an access control setting on the meeting object; and
displaying only retrieved meeting objects having an access control setting that allows a searcher to access the meeting object.

4. The method of claim 2, comprising:
joining a retrieved meeting as an attendee.

5. The method of claim 1, comprising:
displaying a list of meeting objects, wherein the list is filtered according to at least one metadata.

6. The method of claim 1, wherein the metadata includes at least one of: a location, a date, a time, a join URL, a dial-in number, a subject, a meeting organizer, a meeting attendee, a meeting invitee, an agenda, a storage location of the meeting object, a keyword, or a user-defined tag; and
wherein the content includes at least one of: meeting minutes, a meeting note, a meeting recording, or a document.

7. The method of claim 5, comprising:
converting content from a first format to an indexable format.

8. An article comprising a storage medium containing instructions that if executed enable a system to:
create and store a meeting object;
associate the meeting object with metadata; and
index the meeting object according to the metadata.

9. The article of claim 8, comprising instructions that if executed enable the system to:
search for meeting objects via the indexed metadata or content by at least one of:
receiving a search query wherein search criteria for the search query include at least one metadata, and retrieving any meeting objects having metadata matching at least one search criterion; or
browsing a content management system for a meeting site having a link to a meeting, wherein the meeting meets a criterion for the meeting site.

10. The article of claim 9, comprising instructions that if executed enable the system to:
configure an access control setting on the meeting object; and
display only retrieved meeting objects having an access control setting allows a searcher to access the meeting object.

11. The article of claim 9, comprising instruction that if executed enable the system to join an operator to a retrieved meeting object as an attendee.

12. The article of claim 8, comprising instructions that if executed enable the system to:
display a list of meeting objects, wherein the list is filtered according to at least one metadata.

13. The article of claim 8, wherein the metadata includes at least one of:
a location, a date, a time, a join URL, a dial-in number, a subject, a meeting organizer, a meeting attendee, an agenda, a storage location of the meeting object, a keyword, or a user-defined tag; and
wherein content includes at least one of: meeting minutes, a meeting note, a meeting recording, or a document.

14. The article of claim 8, comprising instructions that if executed enable the system to:
convert content from a first format to an indexable format.

15. An apparatus, comprising:
a meeting server component operative to create a meeting object, associate at least one of metadata or content to the meeting object, and store the meeting object, metadata and content, the meeting server component comprising:
an indexing component operative to index metadata associated with the meeting object; and
a search engine component operative to receive a search query comprising search criteria.

16. The apparatus of claim 15, the search engine component operative to retrieve meeting objects according to the search query, wherein the search criteria include at least one metadata, the retrieved meeting objects having metadata matching at least one search criterion.

17. The apparatus of claim 15, the meeting server component operative to configure an access control setting on the meeting object; and the search engine component operative to display only retrieved meeting objects having an access control setting allows a searcher to access the meeting object.

18. The apparatus of claim 15, the search engine component operative to browse a content management system for a meeting site having a link to a meeting, wherein the meeting meets a criterion for the meeting site.

19. The apparatus of claim 15, wherein the metadata includes at least one of:
a location, a date, a time, a join URL, a dial-in number, a subject, a meeting organizer, a meeting attendee, an agenda, a storage location of the meeting object, a keyword, or a user-defined tag; and
wherein content includes at least one of:
meeting minutes, a meeting note, a meeting recording, or a document.

20. The apparatus of claim 19, wherein the indexing component is operative to convert content from a first format to an indexable format.
